(19) United States
(12) Patent Application Publication
(10) Pub. No.: US 2003/0208460 A1
(43) Pub. Date: Nov. 6, 2003

(54) Methods, systems and data structures to generate and link reports

(75) Inventors: Sreedhar Srikant, Marietta, GA (US); Karen A. Papierniak, Fenton, MI (US); Paul Cereghini, Escondidio, CA (US)

Correspondence Address: JAMES M. STOVER, NCR CORPORATION, 1700 SOUTH PATTERSON BLVD, WHQ4, DAYTON, OH, 45479, US

(73) Assignee: NCR Corporation

(21) Appl. No.: 10/139,576

(22) Filed: May 6, 2002

(51) Int. Cl. G06F 7/00

(52) U.S. Cl. 707/1

(57) ABSTRACT

Methods, systems, and data structures are provided to generate and link reports. Requirements are received and associated with identified report processing objects used to generate report specifications defining a report. In one embodiment, new report processing objects are devised and associated with the requirements and also used in generating the report specifications. Furthermore, report specifications and a data store schema, describing a data store having data used to generate a report, are received. The report specifications and the data store schema are used to generate report metadata that can be linked to a specific report tool used to produce an instance of the report.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in any drawings hereto: Copyright © 2002, NCR Corp. All Rights Reserved.

### FIELD OF THE INVENTION

The present invention relates to generating and linking reports, and in particular to methods, systems, and data structures used to generate report specifications and to generate report metadata used to link report tools.

### BACKGROUND OF THE INVENTION

In today's highly automated business environment, organizations are demanding more real time information to mine and analyze behaviors of their customers. This information permits organizations to develop better Customer Relationship Management (CRM) applications and Business Intelligence (BI) solutions to improve relationships with customers of the organizations and corresponding improve the revenues and/or profits of the organizations.

To facilitate improved BI solutions, organizations have developed data warehouses, which organize and link important customer information from a variety of data stores in a centrally accessible data repository. The data warehouses can include information gathered from various online transaction processing (OLTP) applications that record transactions and or behaviors of customers when the customers interact with the organizations in some way. Various data mining, Word Wide Web (WWW) mining, and Decision Support System (DSS) applications can be used against the data warehouse of an organization to create desired BI solutions.

Moreover, organizations employ/contract business analysts to develop Online Analytical Processing (OLAP) specifications, which are then translated by software developers into OLAP applications and linked to commercially available OLAP tools, in order to selectively and easily extract and view information, included within a data store, from different perspectives. OLAP applications typically operate off of a multidimensional data store as opposed to a relational database that is generally associated with two dimensions. A multidimensional data store can consider each data hierarchy (e.g., product line, geography, sales region, time period, and the like) as an independent dimension.

Additionally, an OLAP data store need not be as large as a conventional data warehouse, since not all transactional data is required for OLAP applications performing trend analysis. Furthermore, OLAP applications can be used by organizations to analyze data warehouses for understanding and interpreting data. As is clear to one of ordinary skill in the art, well-developed OLAP specifications assist an organization in creating better BI solutions; therefore the business analysts and software developers are vital resources within the organization.

However, OLAP specifications are largely developed by business analysts and software developers from scratch using business requirements that can be provided in a variety of ad hoc formats (e.g., a word processor document, a paper document, an electronic mail (email), a facsimile, a WWW page, and the like). Additionally, often a variety of previously developed OLAP objects (e.g., OLAP processing functions used to perform standard metrics, filters, data store queries, and the like) are generally not readily available and accessible to a business analyst and software developer when developing OLAP specifications. As a result, OLAP objects proliferate and can be redundantly created throughout the organization. This increases the development cycle when creating the OLAP applications, and increases the maintenance and support associated with the organization's OLAP objects, especially when the OLAP objects are easily understood by the business analyst or developer.

Moreover and as previously presented, even when a business analyst creates an OLAP specification, the resulting OLAP specification must still be embodied in an OLAP application by a software developer. The OLAP application is a metadata processing data format that can be used by a commercially available OLAP tool (e.g., MicroStrategy, Cognos, and others) to process the OLAP specification into one or more instances of an OLAP report using an OLAP data store.

Correspondingly, the OLAP specification is translated into the metadata processing language format by using the OLAP specification and an OLAP data store schema that defines the OLAP data store (e.g., the data necessary to generate instances of OLAP reports being defined by the OLAP specification). A commercially available OLAP tool can then use the metadata and the OLAP data store to generate instances of a report. Each OLAP tool maintains its own metadata format in order to generate instances of the report, which can then be consumed by the organization.

Accordingly, if the organization switches OLAP tools or desires to use multiple OLAP tools, another development effort is required to port from a source metadata format to any target metadata formats. As is readily apparent, generating metadata from specifications and schemas, and/or porting metadata from original formats to target formats can be time consuming and expensive for an organization.

As is apparent, there exists a need for providing techniques that better collect business requirements and generate business specifications. Moreover, improved reuse of processing objects is desirable in order to reduce development cycles and maintenance expenses associated with generating the business specifications. Additionally, there exists a need for improved techniques to automatically generate, convert, and link report metadata, associated with the business specifications and schemas, to specifically desired report tools. With such techniques, organizations can better develop BI solutions in timely and cost effective manners.

### SUMMARY OF THE INVENTION

In various embodiments of the present invention, reports specifications and report metadata are generated. The report specifications are associated with report processing objects that are operable to process portions of a report defined by the report specifications. The report metadata defines reports in a data format required by specific report tools. In this way, the generation of report specifications is automated, and the appropriate report metadata is linked to specifically desired report tools for processing instances of the reports.

More specifically and in one embodiment of the present invention, a method of generating report specifications is provided. Requirements are received and existing objects associated with processing a number of the requirements are identified. Furthermore, report specifications are generated from the requirements and the existing objects.

In another embodiment of the present invention, a method of generating metadata for use by a report id presented. Report specifications and a data store schema are received. Moreover, metadata is generated for the report by using the report specifications and the data store schema.

In still another embodiment of the present invention, a report specification generation system is described. The report specification system includes one or more business requirements, one or more existing report processing objects. Further, the report specification system includes a new report processing object set of executable instructions that interactively devises one or more new report processing objects and a report specification generation set of executable instructions that interactively acquires the one or more business requirements and assigns one or more of the existing report processing objects to a number of the acquired one or more business requirements, and that interactively assigns one or more of the new report processing objects to a number of the acquired one or more business requirements devised by the new report processing object set of executable instructions to generate report specifications.

In yet another embodiment of the present invention, a report linking system is presented. The report linking system includes one or more report specifications, a data store schema, and a linking set of executable instructions. The linking set of executable instructions uses the one or more report specifications and the data store schema to generate and link metadata, associated with a report, to a report processing set of executable instructions.

Still other aspects of the present invention will become apparent to those skilled in the art from the following description of various embodiments. As will be realized the invention is capable of other embodiments, all without departing from the present invention. Accordingly, the drawings and descriptions are illustrative in nature and not intended to be restrictive.

### BRIEF DESCRIPTION OF THE DRAWINGS

FIG. 1 is a diagram representing a method for generating report specifications, according to the teachings of the present invention;

FIG. 2 is a diagram representing a method for linking report metadata to a report tool, according to the teachings of the present invention;

FIG. 3 is a diagram representing an architecture for generating report specifications and report metadata, according to the teachings of the present invention;

FIG. 4 is a diagram representing one example for generating report metadata, according to the teachings of the present invention;

FIG. 5 is a flowchart representing a method of generating report specifications, according to the teachings of the present invention;

FIG. 6 is a flowchart representing a method of generating metadata for use by a report, according to the teachings of the present invention;

FIG. 7 is a diagram of a report specification generation system, according to the teachings of the present invention; and

FIG. 8 is a diagram of a report linking system, according to the teachings of the present invention.

### DETAILED DESCRIPTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

Software for the system is stored on one or more computer readable media. In one embodiment the software is stored on secondary storage, such as a disk drive, and loaded into main memory and cache of the computer as needed. The software is written in the form of executable instructions that generally provide a single function or subsets of related functions. However, in various embodiments, the software comprises a single module or many modules, and there is no requirement that functions be grouped together. Hardware and/or firmware are used to implement the invention in further embodiments. The software may implement the functions, or simply facilitate the performance of the function by a human by providing menu driven interfaces, or other means of providing information to the system for data storage.

Business requirements refer to items of interest to business units of an organization. For example, an organization can fund a business unit to pursue a project, the project than has a set goal (e.g., tracking and comparing electronic shoppers over time that visit the organizations WWW site, and the like). In order to satisfy the project goal, the business unit will develop business-tracking items of interest (e.g., total number of electronic shoppers visiting the WWW site, total number of unique electronic shoppers visiting the WWW site, total number of new customers visiting the WWW site, purchasing totals, and the like). Business requirements can be collected in a variety of formats (e.g., a word processor document, a paper document, an electronic mail (email), a facsimile, a WWW page, and the like) and provided to a business analyst.

The business analyst then takes the business requirements and produces a more detailed definition and analyses that are conventionally used by a software developer to generate a report application. The specifications will define various types of analyses that can be generated by report application to provide the business unit with information in evaluating the project within the organization. For example, the specifications can define data store dimensions that will be needed to satisfy the business requirements (e.g., a product line, a geographic area of interest, a time period, a specifically defined trait of a shopper, and the like). The specifications can also define display formats for the report application, display views (e.g., view by a specific trait) for the report application, sorting or ranking requirements for data items listed by the report application, any processing filters used by the report application, and others. Additionally, the specifications can include cross-reference linking metrics to reports defining metrics by formulas and detailed definitions (e.g., billing cycle is every 30 days, when the billing cycle is not equivalent to a billing month).

In a typical scenario, the business specifications are then passed to a software developer in a variety of formats (e.g., a word processor document, a paper document, an electronic mail (email), a facsimile, a WWW page, and the like). The software developer will use a data store schema that defines a data store housing that data that is tracking the items of interest for the project and the business specifications to produce report metadata (e.g., a report application). Report metadata is a processing language format that is recognized by a commercially available report tool. With the report metadata and report tool, a business user can then generate instances of a report to analyze information related to the project.

In various embodiments of the present disclosure, the above defined process of gathering business requirements and producing and linking report metadata is automated within the organization. This is achieved, in some embodiments, by providing tools to the business analyst to collect business requirements within the tools and interactively providing for selection within the tools one or more report processing objects (e.g., existing filters, metrics, data store queries, and the like), such that the business analyst can interactively select and assign appropriate report processing objects to the appropriate business requirements in an automated fashion. As one skilled in the art readily appreciates, in some embodiments, this can be achieved using a graphical user interface (GUI) where the report processing objects are retrieved from an organization's data store and made available to the business analyst for selection, such that the business analyst drags and drops desired report objects into the GUI. Moreover, in some embodiments, the GUI also permits the business analyst to devise and assign new report processing objects, which can then be stored for subsequent reuse within the organization's data store.

Also, in some embodiments, when the business analyst completes interactions with the tools of the present disclosure, the resulting specification is stored in a highly portable data format, such as Extensible Markup Language Format (XML). Once the interactively created specifications are in the XML format, additional tools can be provided to publish or render the specification to a variety of desired data formats (e.g., a Portable Document Format (PDF), a Hypertext Markup Language Format (HTML), a word processing format, a visual modeling format, and others).

Next, and in still more embodiments, the specifications in XML format can be provided to additional tools of the present disclosure for the automated processing of the specifications into report metadata that can be linked to a specific report tool. In these embodiments, the XML specifications are inputted into the additional tools along with a data store schema defining the data store that houses information required to produces instances of a report that will be generated by report tool using the report metadata. In some embodiments, the data store schema is first translated into an XML schema before being inputted into the additional tools. The additional tools use the XML provided specifications, data store schema, and reporting tool metadata to produce an intermediate report metadata in an XML format by using an internal accessible XML schema that defines the intermediate report metadata. Next, the report metadata can be published or rendered to a variety of commercially available report metadata formats and automatically provided to the appropriate report tool for processing instances of reports associated with the intermediate report metadata.

As one of ordinary skill in the art now understands and will further understand upon reading the various embodiments described in detail below, the present disclosure automates an organization's development cycle associated with translating business requirements into specific report applications created for a variety of report tools. This is particularly well suited for BI solutions developed by an organization using OLAP tools, however, the techniques presented herein can be also used with any business applications and report tools within the organization to automate the development cycle associated with producing report applications.

Furthermore and in more embodiments of the present invention, the various tools of the present disclosure are implemented as a GUI interfaces using WWW pages within a WWW browser. Moreover, the data store is a Teradata warehouse, distributed by NCR Corporation of Dayton, Ohio. Furthermore, various BI solutions can be developed with the present invention and embodied within a Teradata Customer Analysis product, distributed by NCR Corporation of Dayton, Ohio. Of course it is readily apparent to one of ordinary skill in the art that any interface, data store, or BI solutions can be used with the tenets of the present invention, and all such implementation decisions are intended to fall within the scope of the present disclosure.

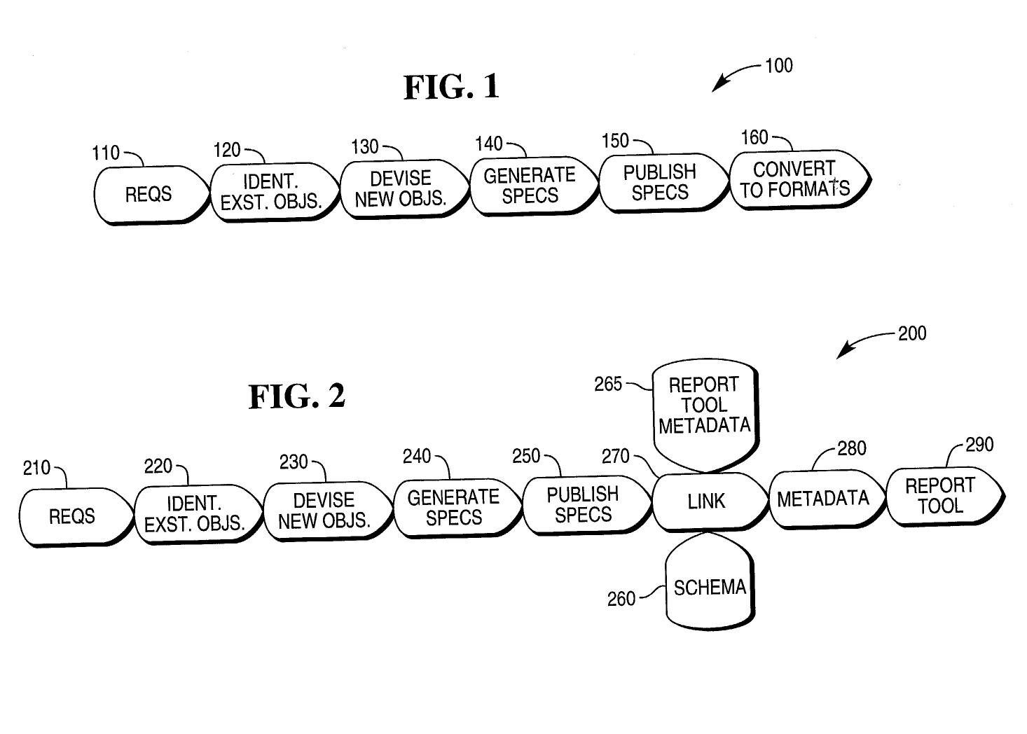

FIG. 1 illustrates a diagram representing one method 100 for generating report specifications, according to the teachings of the present invention. Initially, business requirements are received in 110. In some embodiments, the business requirements are received in electronic format, and represent responses to a standard set of business questions developed for a business project. The business requirements are received in a specification's tool and displayed to a business analyst.

Furthermore, the tool retrieves existing report processing objects (e.g., filters, metrics, data store queries, and the like) from a processing object data store and makes the report processing objects available for selection to the business analyst. The report processing objects can include descriptive information to assist the analyst in selection of the appropriate processing objects. Moreover, the report processing objects can be provided as a viewable list to the business analyst and/or the analyst can be provided a search field to directly search for a desired processing object. In 120, the business analyst uses the requirements and the existing report processing objects to identify and associate desired processing objects with the specifications that are being interactively generated by the tool.

In some instances, the business analyst will need to devise new report processing objects, since existing report processing objects may not be available for the business analyst to associate with a business requirement. In these instances, the tool provides one or more input screens to the business analyst to interactively devise the new report processing objects in 130. Next, in 140, the business analyst completes the business specifications by saving the session with the tool. This causes the tool to generate the specifications. In some embodiments, the specifications are generated in an XML format.

Once the specifications are generated, then in 150 the specifications can be published and subsequently rendered or converted in 160 to any desired data format (e.g., PDF, HTML, a word processing format, and the like). In this way, method 100 teaches an automated and portable technique for generating and publishing report specifications, as opposed to conventional techniques that are by and large manual, producing specifications in data formats that are generally not portable.

FIG. 2 illustrates a diagram representing one method 200 for linking report metadata to a report tool. Similar to FIG. 1, business requirements are received within a tool in 210. Next, the tool permits the interactive selection and identification of existing report processing objects in 220. And in 230, any new report processing objects can be devised within the tool. In 240, the specifications are generated and published in a desired data format in 250.

In 260, a data store schema is provided, that data store schema defines the data store that includes the data necessary to produce instances of reports permitted by the published specifications. In some embodiments, the published specifications are in an XML data format, and the data schema is translated into an XML schema before being provided to the tool in 260. Moreover in 265, the reporting tool metadata is used to produce an instance of the report for a specific desired reporting tool.

Next, the published specifications and the data schema are linked together in 270 to produce report metadata (e.g., a report application) in 280. In some embodiments, the produced report metadata are produced in an XML data format by using an XML schema defining the report metadata in the XML data format. In this way, the produced metadata is in a portable data format that can be translated or rendered to a variety of commercially available metadata formats for use in a variety of commercially available report tools.

Finally, in 290, the generated report metadata is provided or linked to a specific report tool. The report tool uses the report metadata and the data store to produce instances of reports originally requested and defined by the report specifications. As one of ordinary skill in the art now recognizes, method 200 automates the process of generating report applications and makes the resulting applications accessible to a plurality of disparate report tools resulting in improvements over what has been done in the past.

As one of ordinary skill in the art readily appreciates, conventional OLAP and other BI reporting tools do not support the same metadata and have vastly different techniques and syntaxes for retrieving data necessary to generate instances of BI reports. Therefore, the present disclosure represents improvements, since in generating a single instance of a BI report; the single BI report instance can be translated or converted and used with any desired reporting tool (e.g., OLAP, and others), and this is not practical or possible with conventional techniques.

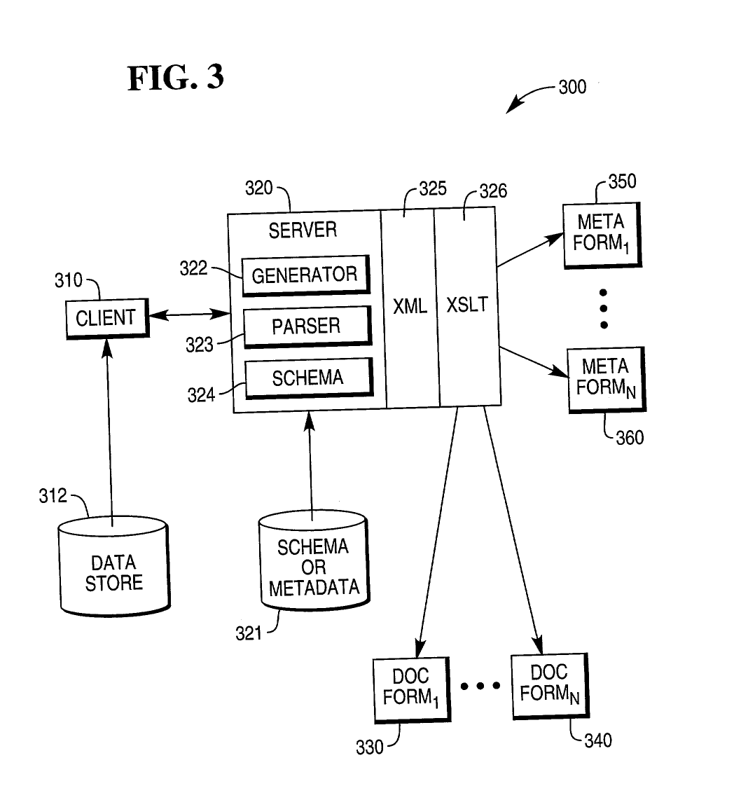

FIG. 3 illustrates a diagram representing an example architecture 300 for generating report specifications and report metadata, according to the teachings of the present invention. The example architecture is presented for purposes of illustration only, since a variety of configurations can be used without departing from the present disclosure.

The architecture 300 includes a client 310 having a data store 312 and a server 320 having access to a schema or metadata 321 associated with report metadata. The server 312 also includes a generator module 322, a parser module 323, and one or more additional schemas 324. Moreover, the server 312 produces data in XML format 325 and is operable to render that data to a plurality of additional data formats by using one or more Extensible Style sheet Language Transformation (XSLT) applications residing on the server 326.

The client 310, in some embodiments, is an interactive tool, interfacing with the server 325 and the data store 312. The client receives business requirements and a list of existing report processing objects (e.g., filters, metrics, data store queries, and the like). The client 310 associates existing report processing objects with desired business requirements and devises any new report processing objects required by the business requirements. The requirements along with the associated report processing objects are sent to the server 320, where the generator 322 uses the parser 323 and the schema 324 to generate business specifications in an XML format 325. An XSLT application 326 can then be used to publish the generated business specifications in a variety of document formats (e.g., 330 and 340).

In still other embodiments, the generated specifications can be further translated into a portable report metadata format (e.g., report application), when the generator 322 takes the generated specifications and a schema 321 associated with report metadata in a portable XML schema and uses the parser and a schema 324 associated with the data store 312 to generate report metadata in an XML format 325, which can then be used by another XSLT application 326 to publish or render the generated report metadata to a variety of report metadata formats (e.g., 350 and 360).

In this way, the architecture 300 illustrates techniques for generating report specifications and report metadata in an automated fashion. Moreover, the generated report specifications and report metadata are in portable data formats (e.g., XML) permitting the report specifications and report metadata to be easily published or rendered to a variety of desired data formats. And, the report metadata is therefore operable to be processed on a variety of commercially available report tools.

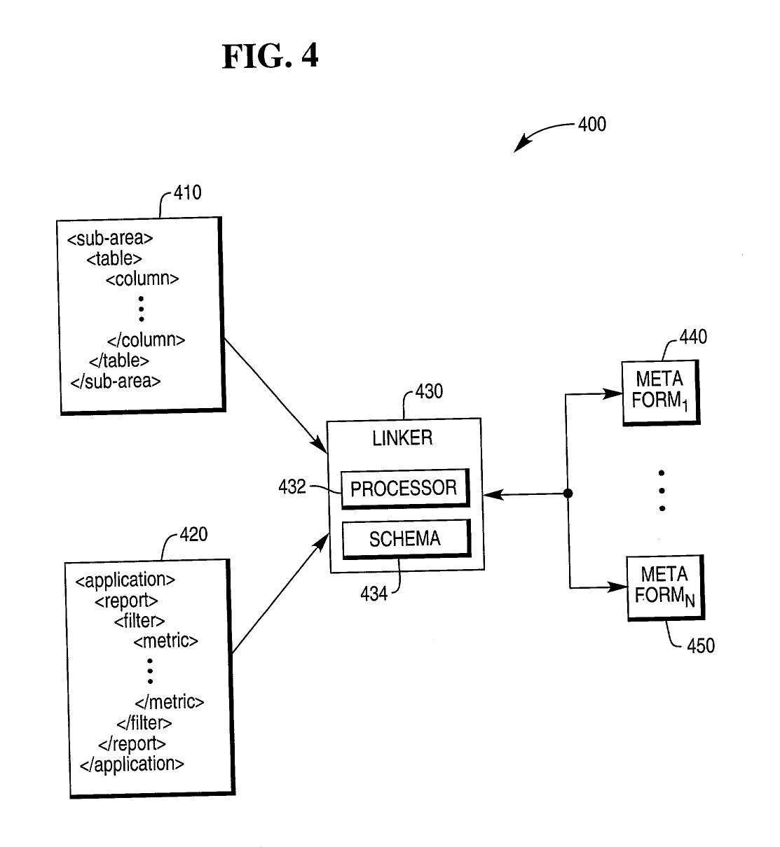

FIG. 4 illustrates a diagram representing one example for generating report metadata, according to the teachings of the present invention. The example depicts a sample data store schema 410. The data store schema 410 defines a data store that houses data needed to produces instances of a report being defined by report specifications 420. The report specifications 420 include report-processing objects (e.g., “<filer>” and “<metric>”). Using an interactive GUI tool generates the report specifications 420, where existing report-processing objects are assigned to business requirements, and where new report processing objects are devised and assigned to the business requirements.

A linker 430 receives the data store schema 410 and the report specifications 420 and uses a processor 432 in combination with an additional schema 434 to generate report metadata in a variety of data formats (e.g., 440 and 450). The additional schema 434 represents an intermediate report metadata format that can be published or rendered into a variety of the data formats (e.g., 440 and 450) as desired.

In some embodiments of FIG. 4, the data store schema 410 is an XML schema, the report specifications 420 are in an XML format, and the additional schema 434 is an XML schema. Furthermore, the report metadata is rendered to a variety of the data formats (e.g., 440 and 450) using an XSLT application. Additionally, and in more embodiments, the additional schema 434 is an OLAP schema when the report specifications 420 are OLAP specifications.

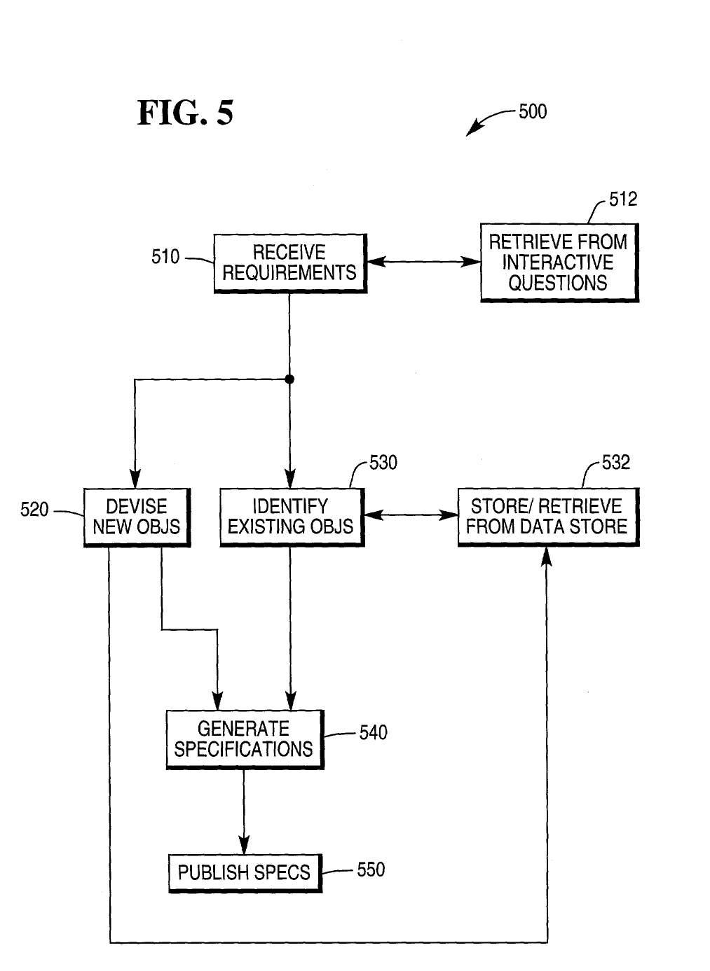

FIG. 5 illustrates a flowchart representing one method 500 for generating report specifications, according to the teachings of the present invention. In 510 business requirements are received. In some embodiments, these requirements are received in an electronic format and made available to a tool implementing method 100. And, in some embodiments the business requirements are retrieved from interactive questions presented to a business user as depicted in 512.

Moreover, one or more existing objects that are associated with processing a number of the received business requirements are made available for selection and assignment to specific business requirements within the tool. Also, in one embodiment, the tool permits one or more new objects associated with processing a number of the received business requirements to be devised in 520. The objects represent processing operations to be performed when generating instances of a report, such as filters, metrics, and data store queries.

In 530, required existing objects, and any newly devised objects, as the case may be, are identified to satisfy the received business requirements. In some embodiments, the required existing objects can be automatically retrieved from a data store as depicted in 532. This permits an organization to reuse existing objects, thereby reducing the development cycle associated with creating redundant objects, and reducing maintenance support by reducing the total number of existing objects that need to be support within the organization. Additionally, any newly devised objects can be stored in the data store in 532, such that the newly devised objects become existing objects with subsequent processing iterations of method 500.

In 540, report specifications are generated from the requirements, the identified existing objects, and any newly devised objects. In one embodiment, the report specifications are generated in an XML format. Moreover, the generated specifications can then be optionally published in 550 to a variety of additional data formats (e.g., PDF, HTML, a word processing format, and the like).

Also, in some embodiments, the report specifications are OLAP specifications that have been created in an OLAP metadata format for use by an OLAP tool to generate instances of reports defined by the OLAP specifications.

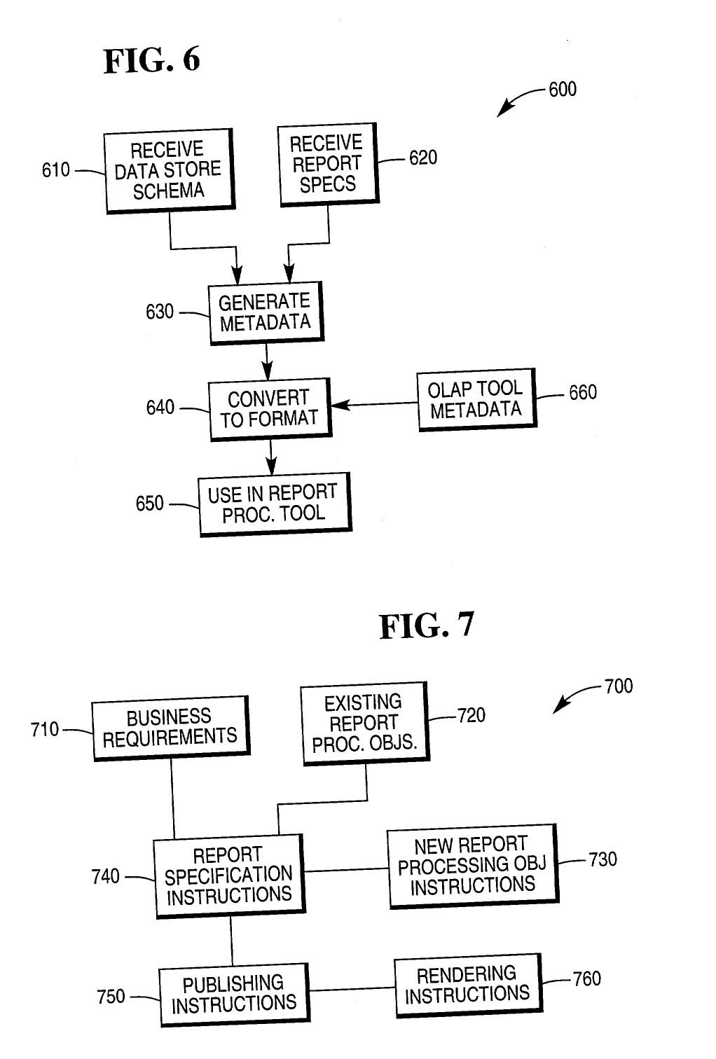

FIG. 6 illustrates a flowchart representing one method 600 for generating report specifications, according to the teachings of the present invention. In 610, a tool implementing method 600 receives a data store schema. The data store schema defines a data store that houses data needed by a report tool to generate instances of a report. In some embodiments, the data store schema is an XML schema. In other embodiments, the data store schema is received in a format native to the data store and is translated into an XML schema.

In 620, report specifications are received, in some embodiments the report specifications are received from the output of processing from method 500 depicted in FIG. 5. Moreover, in one embodiment, the report specifications are received in an XML format. The data store schema and the report specifications are used to generate report metadata in 630. By mapping the report specifications to the appropriate data store fields defined in the data store schema, and by using a metadata schema that defines the report metadata format along with an OLAP tool specific metadata provided in 660, the report metadata can be generated. Moreover, when the specifications and the schema are in XML format an XML parser and an XSLT application can be used to generate the report metadata.

The generated report metadata is converted in 640 to a desired metadata format that is compatible with a report-processing tool, such that the report-processing tool uses the converted report metadata as a report application to produce one or more instances of a report using the data store in 650. In some embodiments, the report specifications are OLAP specifications, the report metadata is an OLAP metadata, and the report-processing tool is an OLAP tool. Furthermore, in some embodiments, the OLAP specifications are associated with an organization's BI application and the resulting reports from using the BI application is a BI report used to enhance the organization's understanding of their business.

FIG. 7 illustrates a diagram of one report specification generation system 700, according to the teachings of the present invention. The report specification system 700 includes one or more business requirements 710, one or more existing report processing objects 720, a new report processing set of executable instructions (NS) 730, and a report specification generation set of executable instructions (RS) 740. The report processing objects represent operations (e.g., filters, metrics, data store queries) that need to be performed against a data store to generate one or more instances of reports required by the business requirements 710. In some embodiments, the report specification system 700 also includes a publishing set of executable instructions (PS) 750, and a rendering set of executable instructions (RS) 760.

The RS 740 interactively acquires the one or more business requirements 710 and assigns a number of the business requirements 710 to one or more of the existing report processing objects 720. In some embodiments, the RS 740 is embodied within a GUI tool that is interactively communicating with a business analyst of an organization to develop business specifications from the business requirements 710. The existing report processing objects 720 are acquired from a data store and made available within the RS 740 environment, such that the existing report processing objects 720 are more completely identified and reused as an organization develops business specifications.

The NS 730 interact with the RS 740 when new report processing objects need to be devised and associated with the business requirements 710. The RS 740 interactively assigns any new report processing objects to the appropriate business requirements. The RS 740 uses the business requirements 710, the assigned existing report processing objects 720, and the new report processing objects to generate report specifications.

In one embodiment, the PS 750 is used after the report specifications are generated to publish the report specifications in a specific data format, such as an intermediate data format represented in an XML format. In this way, the RS 760 can render the intermediate data format to a plurality of desired data formats (e.g., PDF, HTML, word processing format, and the like). Moreover, in one embodiment of the report specification system 700, the entire system 700 is embodied in and/or accessible from a GUI tool, such as a series of WWW pages operating within a WWW browser and having access to remote services via an Internet connection, where the remotes service can include one or more of the components listed in the system 700 of FIG. 7.

Furthermore, in some embodiments, the generated report specifications are subsequently translated by additional processing into a report metadata format, where the report metadata format represents a report application that is used by a report tool to process instances of reports. And, in some embodiments, the report specifications are OLAP specifications, the report metadata is an OLAP metadata, and the report tool is an OLAP tool.

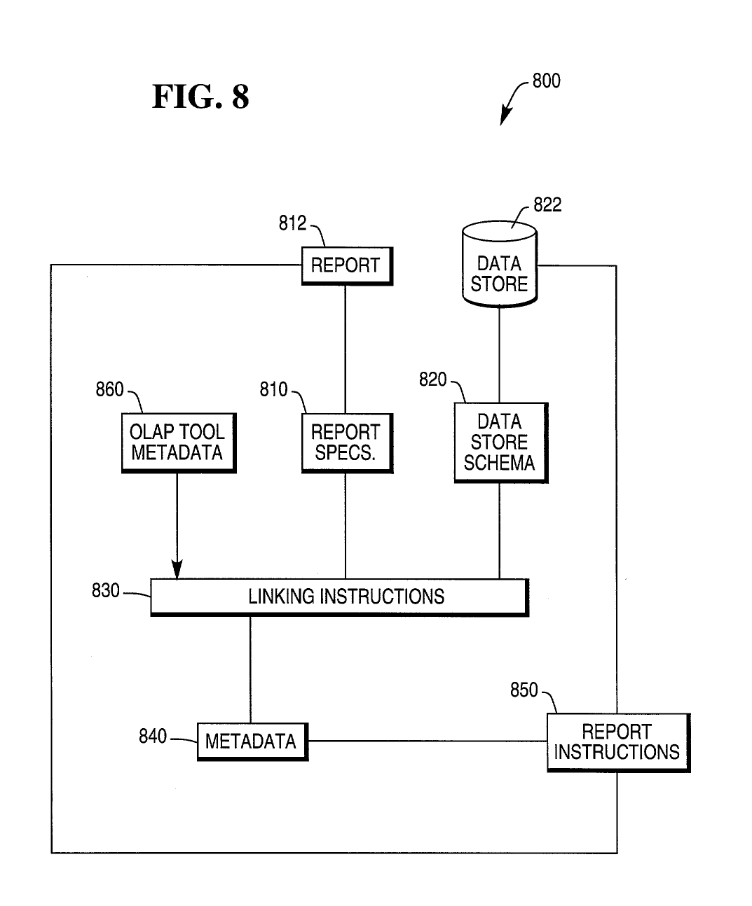

FIG. 8 illustrates a diagram of one report linking system 800, according to the teachings of the present invention. The report linking system 800 includes one or more report specifications 810 associated with a report 812, a data store schema 820 associated with a data store 822, and a linking set of executable instructions (LS) 830. The report linking system 800 also includes generated report metadata 840. Furthermore, the report linking system 800 can also include report-processing set of executable instructions (RS) 850.

The LS 830 uses the report specifications 810, the data store schema 820, and the OLAP tool metadata 860 to generate and link metadata 840 to the RS 850. The metadata 840 is a report application in a format that can be processed by the RS 850 to generate one or more instances of the report 812 by using the metadata 840 and the data store 822. The LS also uses a schema associated with the generated metadata 840 when generating the metadata 840 from the report specifications 810 and the data store schema 820.

In some embodiments, the LS 830 is also operable to receive additional metadata in an additional metadata format and translate the additional metadata in the additional metadata format to the metadata 840 so that the RS 850 can process metadata 850. In this way, a metadata format associated with an additional report processing set of executable instructions can have its metadata format translated to the RS's 850 metadata format and seamlessly process in the RS 850. One technique to achieve this translation is to first translate the additional metadata format into an intermediate format, such as XML, and then use an XSLT application to translate the intermediate format into the required metadata format needed by the RS 850.

Also, in some embodiments, the RS 850 is an OLAP tool, and the metadata 840 is in an OLAP compatible format. Additionally in some embodiments, the LS 830 can use XML parsers and XSLT applications to receive report specifications 810 in an XML format and to receive the data store schema 820 as an XML schema. And, in still more embodiments, the data store schema 820 can be associated with a relational database 820, an OLAP database 820, or a multidimensional database 820 and converted into an XML schema before being used by the LS 830.

As one of ordinary skill in the art now understands upon reading the present disclosure, techniques and systems are provided to automate the generation of report specifications. Moreover, the generated report specifications are automatically published in a variety of desired data formats. And, the report specifications are combined with a data store schema to generate report metadata (e.g. report applications) that can then be automatically linked to a specifically desired report tool for processing.

These techniques of the present invention can also provide a bridge between metadata associated with disparate report tools, such that the metadata of one tool is seamlessly translated and processed on the other tool. Furthermore, the teachings of the present invention offer improved techniques over what has been done in the past, where the generation of report specifications, report metadata, and the linking of report metadata to report tools remain manual processes.

The foregoing description of various embodiments of the invention has been presented for purposes of illustration and description. It is not intended to be exhaustive nor to limit the invention to the precise form disclosed. Many alternatives, modifications, and variations will be apparent to those skilled in the art in light of the above teaching. For example, although various embodiments of the invention have been described as a series of sequential steps, the invention is not limited to performing any particular steps in any particular order. Accordingly, this invention is intended to embrace all alternatives, modifications, equivalents, and variations that fall within the spirit and broad scope of the attached claims.

What is claimed is:

1. A method of generating report specifications, comprising:
receiving requirements;
identifying existing objects associated with processing a number of the requirements; and
generating report specifications from the requirements and the existing objects.

2. The method of claim 1 further comprising, devising new objects associated with processing a number of the requirements and using the new objects when generating the report specifications.

3. The method of claim 1, wherein in generating the report specifications, the report specifications are Online Analytical Processing (OLAP) specifications.

4. The method of claim 3, further comprising publishing the OLAP specifications in an Extensible Markup Language (XML) data format.

5. The method of claim 1, wherein in identifying existing objects, the existing objects are interactively identified and retrieved from a data store.

6. The method of claim 1, wherein in identifying existing objects, the existing objects represent processing modules for performing at least one of filter operations, metric operations, and data store queries.

7. The method of claim 1, wherein in receiving the requirements, the requirements are interactively received in response to a series of interactively presented business questions.

8. A method of generating metadata for use by a report, comprising:
receiving report specifications;
receiving a data store schema; and
generating the metadata for the report by using the report specifications, the data store schema, and reporting tool metadata.

9. The method of claim 8, wherein in receiving the report specifications, the report specifications are received in an Extensible Markup Language (XML) data format.

10. The method of claim 9, wherein in receiving the data store schema, the data store schema is converted into an XML format.

11. The method of claim 10, wherein in generating the metadata, the metadata is generated by using an XML schema for the metadata, and an XML parser.

12. The method of claim 8, further comprising converting the generated metadata to a format for use by a report processing tool that is operable to generate an instance of the report.

13. The method of claim 12, wherein in receiving report specifications, the report specifications are Online Analytical Processing (OLAP) report specifications.

14. The method of claim 8, wherein in receiving the report specifications, the OLAP report specifications are associated with a Business Intelligence (BI) application and the report is a BI report.

15. A report specification generation system, comprising:
one or more business requirements;
one or more existing report processing objects;
a new report processing object set of executable instructions that interactively devises one or more new report processing objects; and
a report specification generation set of executable instructions that interactively acquires the one or more business requirements and assigns one or more of the existing report processing objects to a number of the acquired one or more business requirements, and that interactively assigns one or more of the new report processing objects to a number of the acquired one or more business requirements devised by the new report processing object set of executable instructions to generate report specifications.

16. The system of claim 15, further comprising a publishing set of executable instructions that publishes the report specifications in an Extensible Markup Language (XML) data format.

17. The system of claim 16, further comprising a rendering set of executable instructions that render the report specifications from the XML data format to one or more additional data formats.

18. The system of claim 15, wherein the system is provided as a graphical user interface (GUI).

19. The system of claim 15, wherein the report specifications are translated to metadata used in connection with an Online Analytical Processing (OLAP) report tool to generate one or more instances of a report defined by the metadata.

21. A report linking system, comprising:
one or more report specifications;
a data store schema; and
a linking set of executable instructions that uses the one or more report specifications and the data store schema to generate and link metadata associated with a report to a report processing set of executable instructions.

22. The report linking system of claim 21, wherein the linking set of executable instructions receives an additional metadata in an additional format associated with an additional report processing set of executable instructions and generates and links the metadata associated with the report to the report processing set of executable instructions.

23. The report linking system of claim 22, the metadata and the additional metadata are associated with different Online Analytical Processing (OLAP) metadata formats and the report processing set of executable instructions and the additional report processing set of executable instructions are associated with different OLAP report tools.

24. The report linking system of claim 21, wherein the one or more report specifications are in an Extensible Markup Language (XML) data format and the data store schema is converted to an XML schema before linking set of executable instructions generates and links the metadata to the report processing set of executable instructions.

25. The user interface of claim 24, wherein the linking set of executable instructions is an Extensible Style sheet Language Transformation (XSLT) set of executable instructions.

26. The user interface of claim 21, wherein the data store schema represents a schema associated with a relational database, an OLAP database, or a multidimensional database.
